(19) United States
(12) Patent Application Publication
(10) Pub. No.: US 2011/0150339 A1
(43) Pub. Date: Jun. 23, 2011

(54) APPARATUS, METHOD, AND PROGRAM FOR IMAGE PROCESSING

(75) Inventors: Akifumi Kashiwagi, Tokyo (JP); Yuichi Abe, Tokyo (JP)

(73) Assignee: SONY CORPORATION, Tokyo (JP)

(21) Appl. No.: 12/906,376

(22) Filed: Oct. 18, 2010

(30) Foreign Application Priority Data
Dec. 22, 2009 (JP) 2009-290903

(51) Int. Cl. G06K 9/46

(52) U.S. Cl. 382/190

(57) ABSTRACT

An image processing apparatus includes a face image detector detecting a face image from an image, a reference mask generator generating a reference mask based on the arrangement of parts included in the face image detected by the face image detector, a face color area detector detecting a face color area from the image, and a face image searcher searching for the face image using the reference mask in the face area detected by the face color area detector.

### BACKGROUND OF THE INVENTION

1. Field of the Invention

The present invention relates to an apparatus, method, and program for image processing and, more particularly, to an apparatus, method, and program for image processing that can quickly detect even a rotated face image in a moving picture without reduction in detection accuracy.

2. Description of the Related Art

Methods of detecting a face image in a moving picture have been studied.

For example, Japanese Unexamined Patent Application Publication No. 2009-075926 proposes a method of detecting even a rotated face image using characteristic points.

If the rotation angle of a face image can be detected together with the face image as described above, it is possible to obtain both items only if there is the function for detecting a face image.

### SUMMARY OF THE INVENTION

In the method described in Japanese Unexamined Patent Application Publication No. 2009-075926, the inclination of a face is detected only by the angle formed by the straight line between both eyes and the horizontal line. Accordingly, it is difficult to determine whether a face image is upside down.

Similarly, it is also difficult to determine whether a face image is rotated clockwise or counterclockwise 90 degrees or more, so false recognition may occur.

That is, when recognition processing by face images is applied to the face image detected by the method proposed in Japanese Unexamined Patent Application Publication No. 2009-075926, it is necessary to analyze the extracted face image in detail again to obtain the rotation angle.

In addition, when a method of the related art is used to detect a face image rotated in a moving picture, detection of the face images rotated at any angle may remarkably increase the amount of calculation. This is because, in the related art, it is necessary to search all areas for each scene using face images prepared in advance for each rotation angle when a face image is detected in a moving picture. For example, when a face image that may be rotated at any rotation angle is searched for, it is necessary to search all ranges for each scene for the number of face image patterns corresponding to all rotation angles.

That is, if the amount of calculation for searching for a face image using one face image pattern from one scene is assumed to be s and the rotation angle between face images patterns is assumed to be 1/b degrees, the amount of calculation for searching for a face image rotated at an angle from 0 to 360 degrees is S (=s×b×360).

Although the number of rotation angles for a face image in a particular scene is 1, the face image patterns corresponding to all rotation angles are used to search all areas, probably increasing the amount of calculation and searching time remarkably.

It is desirable to provide an apparatus, method, and program for image processing that can quickly detect a face image without reduction in detection accuracy of the face image.

According to an embodiment of the present invention, there is a provided an image processing apparatus including a face image detection means for detecting a face image from an image, a reference mask generation means for generating a reference mask based on an arrangement of parts included in the face image detected by the face image detection means, a face color area detection means for detecting a face color area from the image, and a face image search means for searching the face area detected by the face color area detection means for the face image using the reference mask.

The image processing apparatus further includes a high frequency component extraction means for extracting high frequency components in the face image detected by the face image detection means, in which the reference mask generation means recognizes the arrangement of the parts included in the face image based on distribution of the high frequency components in the face image detected by the face image detection means and generates the reference mask based on the arrangement of the parts recognized.

The image processing apparatus further includes a high frequency component extraction means for extracting high frequency components in the face color area, in which the face image search means adjusts a size and a position of the reference mask and rotates the reference mask about a certain position on the reference mask so that the reference mask matches the face color area, and searches for the face image by determining whether distribution of the high frequency components detected by the high frequency extraction means matches a positional relationship of the parts in the reference mask.

The face image search means rotates the reference mask about the certain position on the reference mask from a position where the distribution of the high frequency components detected by the high frequency extraction means has a certain relation with a positional relationship of parts in the reference mask position and the face image search means searches for the face image by determining whether the distribution of the high frequency components detected by the high frequency extraction means matches the positional relationship of the parts in the reference mask.

An image processing method according to the embodiment of the present invention includes the steps of detecting a face image from an image, generating a reference mask based on an arrangement of parts included in the face image detected by the step of detecting the face image, detecting a face color area from the image, and searching the face color area detected by the step of detecting the face color area for the face image using the reference mask.

A program according to the embodiment of the present invention instructs a computer to execute a process including the steps of detecting a face image from an image, generating a reference mask based on an arrangement of parts included in the face image detected by the step of detecting the face image, detecting a face color area from the image, and searching the face color area detected by the step of detecting the face color area for the face image using the reference mask.

According to the embodiment of the present invention, the face image is detected from an image, the reference mask is generated based on the arrangement of parts included in the detected face image, the face color area is detected from the image, and the reference mask is used to search the detected face color area for the face image.

The image processing apparatus according to the embodiment of the present invention may be a standalone device or a block that performs image processing.

According to the embodiment of the present invention, it is possible to quickly detect a face image even if it is rotated from an input image without reduction in accuracy at which the face image is extracted from the input image.

### BRIEF DESCRIPTION OF THE DRAWINGS

FIG. 1 shows a configuration example of a face image extraction apparatus according to an embodiment of the present invention.

FIG. 2 is a flowchart illustrating face image extraction processing.

FIG. 3 is a flowchart illustrating reference mask information generation processing.

FIG. 4 illustrates reference mask information generation processing.

FIG. 5 is a flowchart illustrating face image search processing.

FIG. 6 illustrates face image search processing.

FIG. 7 illustrates face image search processing.

FIG. 8 illustrates face image search processing.

FIG. 9 illustrates a configuration example of a general purpose personal computer.

### DESCRIPTION OF THE PREFERRED EMBODIMENTS

### Configuration Example of a Face Image Extraction Apparatus

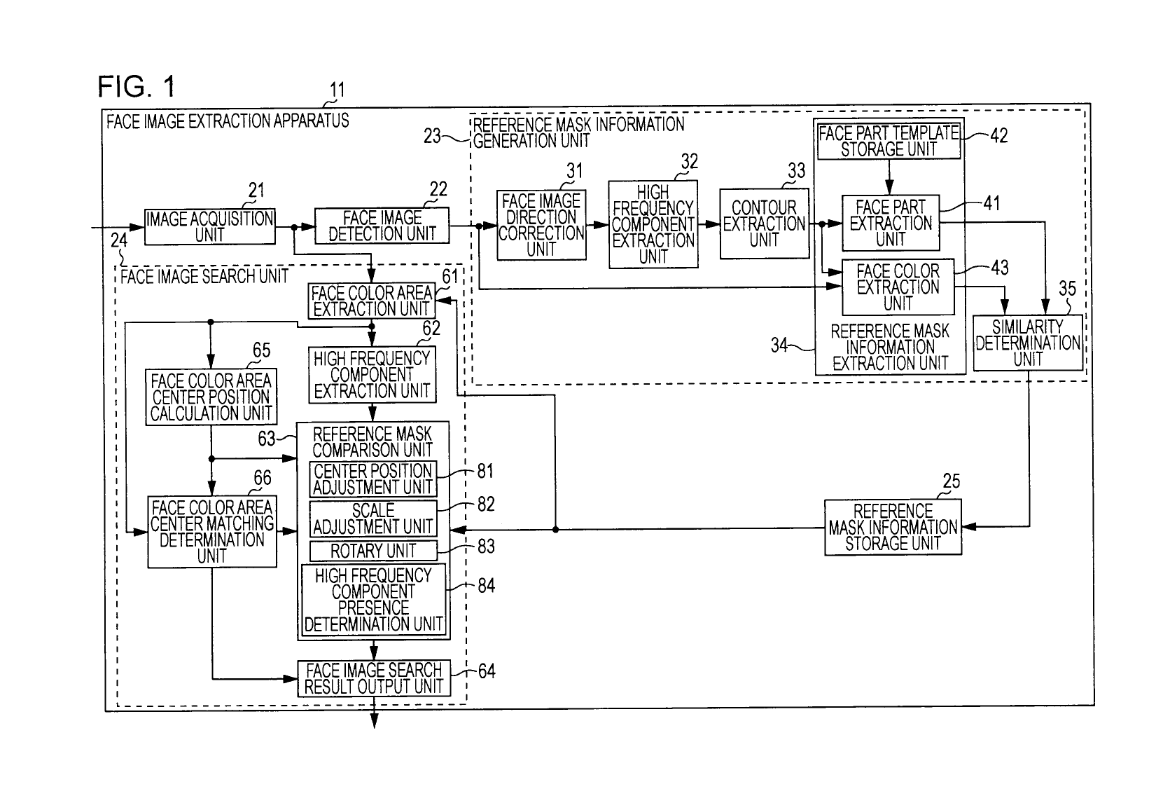

FIG. 1 shows a configuration example of a face image extraction apparatus according to an embodiment of the present invention. The face image extraction apparatus 11 in FIG. 1 searches an input image for a face image and extracts it. More specifically, the face image extraction apparatus 11 extracts an input image from a face image using a method of the related art and generates reference mask information. Next, the face image extraction apparatus 11 searches the input image for a face color area, extracts the high frequency components in the searched face color area, and searches for the face image using a reference mask based on the reference mask information. More specifically, the face image extraction apparatus 11 adjusts the size of the reference mask based on the reference mask information so that the reference mask matches the face color area, and searches the face image in comparison with the high frequency components in the face color area while rotating the reference mask about a certain position in the reference mask.

The face image extraction apparatus 11 includes an image acquisition unit 21, a face image detection unit 22, a reference mask information generation unit 23, a face image search unit 24, and a reference mask information storage unit 25.

The image acquisition unit 21 acquires an input image and supplies it to the face image detection unit 22 and the face image search unit 24.

The face image detection unit 22 detects an area included in the face image from the input image supplied by the image acquisition unit 21 using the detection method of the related art as proposed by Japanese Unexamined Patent Application Publication No. 2009-075926 and supplies this area to the reference mask information generation unit 23 as the face image.

The reference mask information generation unit 23 generates, as the reference mask information, information of the reference mask based on the face image supplied from the face image detection unit 22 and stores the reference mask information in the reference mask information storage unit 25. The reference mask information, which is used to identify the face image to be searched for, includes the contour shapes and barycentric positions of parts such as the eyes, nose, and mouth in the face image detected by the face image detection unit 22, as well as face color information obtained from the face image. The face shape generated from this reference mask information is the face image to be searched for, that is, the reference mask.

The reference mask information generation unit 23 includes a face image direction correction unit 31, a high frequency component extraction unit 32, an contour extraction unit 33, a reference mask information extraction unit 34, and a similarity determination unit 35. The face image direction correction unit 31 rotates the face image supplied from the face image detection unit 22 so that the straight line between the barycentric positions of left and right eyes in the face image becomes level, and supplies the corrected face to the high frequency component extraction unit 32.

The high frequency component extraction unit 32 extracts high frequency components by applying a high pass filter to the corrected face image and supplies them to the contour extraction unit 33. Based on an edge image including high frequency components in the face image supplied from the high frequency component extraction unit 32, the contour extraction unit 33 extracts the outer shape indicating the outermost circumference as the contour shape of the face image and supplies the contour shape to the reference mask information extraction unit 34 together with the edge image including high frequency components.

The reference mask information extraction unit 34 extracts reference mask information used to configure the reference mask based on the face image supplied from the face image detection unit 22 and the contour shape of the face image and the edge image supplied from the contour extraction unit 33. More specifically, the reference mask information extraction unit 34 includes a face part extraction unit 41, a face part template storage unit 42, and a face color extraction unit 43.

The face part template is a template in which the presence areas of face parts such as eyes, a nose, and a mouth are specified in the contour shape of a general face image. Since the presence areas of the parts in the face part template are obtained statistically, when the face part template is superimposed so as to match the contour shape of the face, the parts are contained within the corresponding presence areas for most face images.

The face part extraction unit 41 reads the face part template stored in the face part template storage unit 42 and arranges the template so that the contour shape of the template matches that of information of high frequency components (edge image) supplied from the contour extraction unit 33. In the presence areas of the eyes, nose, and mouth that are set in the face part template, the face part extraction unit 41 extracts the outermost circumference shapes of the edge images as the contour shape information of the face parts and supplies them to the similarity determination unit 35. The face color extraction unit 43 extracts color information of the face image in areas other than the presence areas within the contour shapes supplied from the contour extraction unit 33 in the range below the straight line between the barycentric positions of left and right eyes. The face color extraction unit 43 supplies the minimum value, maximum value, and average value of the extracted color information to the similarity determination unit 35 as face color information.

The similarity determination unit 35 compares the outer contour shape, the contour shapes of the parts, the barycentric positions of the parts, and the face color information that are reference mask information from the reference mask information extraction unit 34 with the reference mask information that has been stored in the reference mask information storage unit 25 to determine the similarity therebetween. If there is no similar reference mask information, the similarity determination unit 35 stores the extracted reference mask information as new reference mask information in the reference mask information storage unit 25. Otherwise, the similarity determination unit 35 assumes that the extracted reference mask information has already been stored and discards the extracted reference mask information.

The face image search unit 24 sequentially reads reference mask information stored in the reference mask information storage unit 25, configures a reference mask, makes comparison while rotating the reference mask in the area in which the face color information of the image supplied from the image acquisition unit 21 is detected, and, if a coincidence is found, the reference mask is detected as a face image. The face image search unit 24 includes a face color area extraction unit 61, a high frequency component extraction unit 62, a reference mask comparison unit 63, a face image search result output unit 64, a face color area center position calculation unit 65, and a face color area center matching determination unit 66.

The face color area extraction unit 61 reads the face color information of the reference mask information in the reference mask information storage unit 25 and extracts the face color area from the image supplied from the image acquisition unit 21, and supplies it to the high frequency component extraction unit 62, the face color area center position calculation unit 65, and the face color area center matching determination unit 66. The high frequency component extraction unit 62 extracts high frequency components in the face color area of the face image supplied from the face color area extraction unit 61 and supplies the extracted high frequency components to the reference mask comparison unit 63.

The reference mask comparison unit 63 configures a reference mask from the reference mask information stored in the reference mask information storage unit 25, makes adjustment according to the size of the face color area supplied by the high frequency component extraction unit 62, and determines whether there is a match by comparison with the high frequency components in the face color area while rotating the reference mask about a certain position. When there is a match, the reference mask comparison unit 63 determines that the face image corresponding to the reference mask information stored in the reference mask information storage unit 25 has been found and supplies the searched face image to the face image search result output unit 64. The face image search result output unit 64 outputs the searched face image.

More specifically, the reference mask comparison unit 63 includes a center position adjustment unit 81, a scale adjustment unit 82, a rotary unit 83, and a high frequency component presence determination unit 84. The center position adjustment unit 81 adjusts the center position of the reference mask generated on the basis of the reference mask information to the center position of the face color area. The scale adjustment unit 82 adjusts the size of the reference mask according to the size of the face color area. The rotary unit 83 rotates the reference mask whose scale was adjusted about the center position at a certain angle unit. The high frequency component presence determination unit 84 compares the contour shape of the face color area with those of parts of the reference mask to determine whether the face image is searched for according to the presence or absence of a match. When the contour shape of the face color area matches those of parts of the reference mask and the face image is searched for, the high frequency component presence determination unit 84 outputs the face color area in the position corresponding to the reference mask as the search result.

The face color area center position calculation unit 65 calculates the center position from the face color area and supplies the center position to the reference mask comparison unit 63 and the face color area center matching determination unit 66. The face color area center matching determination unit 66 determines whether the face color area center position supplied from the face color area center position calculation unit 65 is present in an appropriate position as the center position of the face color area and outputs the determination result to the reference mask comparison unit 63 and the face image search result output unit 64.

### [Face Image Extraction Processing]

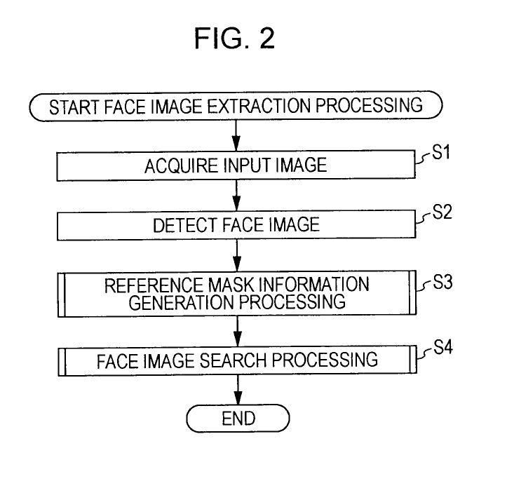

Next, face image extraction processing by the face image extraction apparatus 11 will be described with reference to the flowchart in FIG. 2.

In step S1, the image acquisition unit 21 acquires an input image and supplies the input image to the face image detection unit 22 and the face image search unit 24.

In step S2, the face image detection unit 22 detects a face image based on information of the input image and supplies the detected face image to the reference mask information generation unit 23. More specifically, the face image detection unit 22 detects colored areas such as the eyes, nose, and mouth for which arrangement is predictable in advance, and outputs the detected area as a face image. That is, the face image detection unit 22 does not perform strict detection processing, but detects only easy-to-detect portions as face image areas from information in an image.

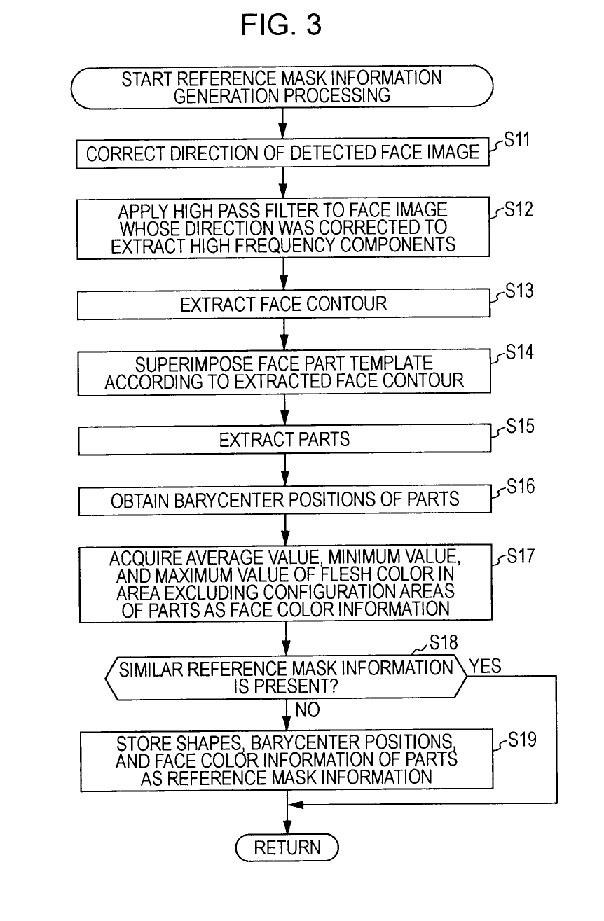

In step S3, the reference mask information generation unit 23 performs reference mask information generation processing based on the face image supplied from the face image detection unit 22, and stores the generated reference mask information in the reference mask information storage unit 25. Reference mask information generation processing will be described in detail later with reference to the flowchart in FIG. 3.

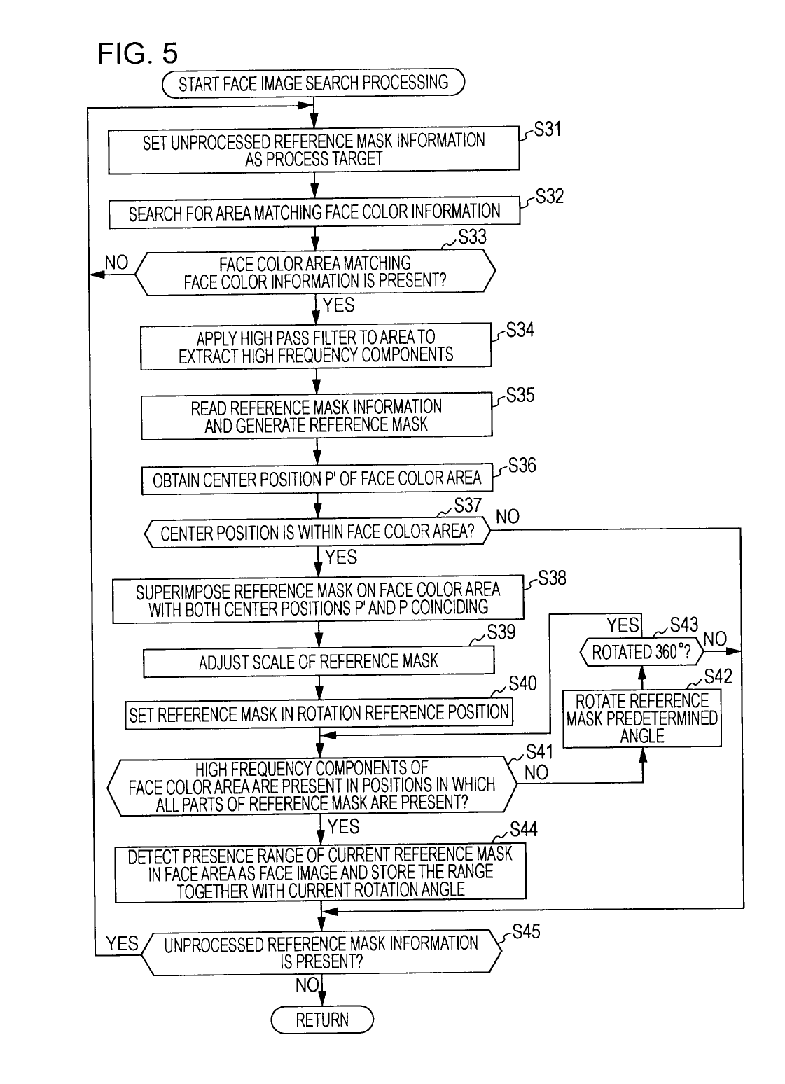

In step S4, the face image search unit 24 reads the reference mask image, performs face image search processing, searches for the face image based on the reference mask, and outputs the face image. Face image search processing will be described in detail later with reference to the flowchart in FIG. 5.

That is, the face image extraction apparatus 11 detects the face image from the input image using a simple method of the related art and generates reference masks including the contour shapes and barycentric positions of the parts based on the detected face image. The face image extraction apparatus 11 extracts a face color area from the input image and checks whether the high frequency components in the face color area match the contour shapes and barycentric positions of the parts in the reference mask. When there is a match, the face image extraction apparatus 11 outputs the searched face image as the extraction result.

That is, the face image extraction apparatus 11 uses the simple face image search method to generate the reference mask information used as the reference. Using the reference mask, the face image extraction apparatus 11 extracts the face image at a high speed by searching for the face image that is not detected by the simple method of the related art.

### [Reference Mask Information Generation Processing]

Next, reference mask information generation processing will be described with reference to the flowchart in FIG. 2.

In step S11, the face image direction correction unit 31 corrects the rotation direction of the face image based on the face image supplied from the face image detection unit 22. More specifically, the face image direction correction unit 31 the rotation direction of the face image so that the straight line between the left and right eyes included in the face image from the face image detection unit 22 becomes level.

In step S12, the high frequency component extraction unit 32 applies a high pass filter such as the Sobel filter, Prewitt filter, or Laplacian filter to the face image whose rotation direction was corrected to extract an edge image including high frequency components, and supplies the edge image to the contour extraction unit 33.

In step S13, the contour extraction unit 33 extracts the face contour from the edge image including high frequency components in the face image, and supplies the face contour to the reference mask information extraction unit 34.

In step S14, the face part extraction unit 41 of the reference mask information extraction unit 34 reads a face part template stored in the face part template storage unit 42 and superimposes the template on the extracted face contour to identify the positions of the parts of the face. More specifically, the face part extraction unit 41 superimposes, for example, the face part template BM indicated by a solid line on the edge image F indicated by a dotted line, which includes high frequency components in the face image.

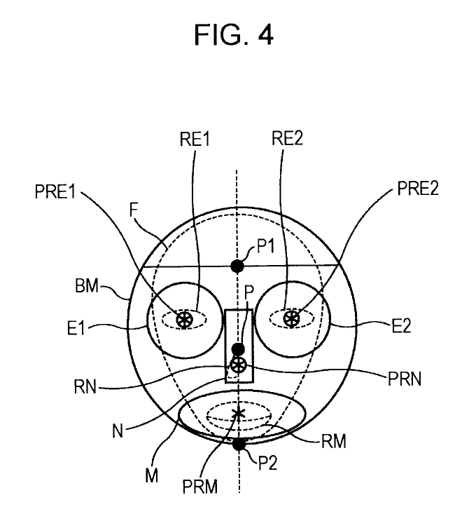

That is, the face part template BM contains the right eye area E1, the left eye area E2, the nose area N, and the mouth area M, which are indicated by solid lines in FIG. 4 and represent the approximate presence areas of face components. The right eye area E1, the left eye area E2, the nose area N, and the mouth area M are obtained from the presence distribution (in the face image) of the right eye, left eye, nose, mouth, which are face components. Accordingly, when the face part template BM is superimposed on the edge image F including high frequency components in the face image, the right eye, left eye, nose, and mouth in the face image indicated by the edge image F are present in the right eye area E1, the left eye area E2, the nose area N, and the mouth area M, respectively.

The face part extraction unit 41 adjusts the face part template BM so that the upper edge P1, which is present near the hairline, and lower edge P2 of the face part template BM match the hairline and the lower end of the edge image F of the face image and superimposes the face part template BM on the edge image F. Then, the face part extraction unit 41 obtains the middle point P of the upper edge P1 and the lower edge P2.

In step S15, the face part extraction unit 41 detects, as the contour shapes of the right eye, left eye, nose, and mouth, the outermost contour shapes of the edge image F in the right eye area E1, the left eye area E2, the nose area N, and the mouth area M when the face part template BM is superimposed on the edge image F of the face image. That is, in FIG. 4, the outermost circumference shape of the edge image F in the right eye area E1 is extracted as the right eye contour shape RE1. The outermost circumference shape of the edge image F in the left eye area E2 is extracted as left eye contour shape RE2. The outermost circumference shape of the edge image F in the nose area N is extracted as nose contour shape RN. The outermost circumference shape of the edge image F in the mouth area M is extracted as mouth contour shape RM.

In step S16, the face part extraction unit 41 obtains the barycentric positions of parts such as the eyes, nose, and mouth and the positions in the face part template BM that correspond to the barycentric positions and supplies these positions as well as position information of the middle point P to the similarity determination unit 35. That is, in this processing, the face part extraction unit 41 extracts the contour information of the parts such as the left and right eyes, nose, and the mouth and the positions in the face part template BM that correspond to the barycentric positions and supplies them to the similarity determination unit 35.

For example, in the case shown in FIG. 4, the barycentric position PRE1 is obtained as the barycentric position of the right eye contour shape RE1 and the position in the face part template BM that corresponds to the barycentric position PRE1 is obtained. In addition, the barycentric position PRE2 is obtained as the barycentric position of the left eye contour shape RE2 and the position in the face part template BM that corresponds to the barycentric position PRE2 is obtained. In addition, the barycentric position PRM is obtained as the barycentric position of the mouth contour shape RM and the position in the face part template BM that corresponds to the barycentric position PM is obtained.

In step S17, the face color extraction unit 43 extracts the color information of the area that is present below the straight line between the barycentric positions PRE1 and PRE2 and does not include the areas of the right eye contour shape RE1, the left eye contour shape RE2, the nose contour shape RN, and the mouth contour shape RM in the edge image F. Then, the face color extraction unit 43 obtains the minimum value, maximum value, and average value of the extracted colors and supplies these values to the similarity determination unit 35 as face color information. That is, the color information extracted by the face color extraction unit 43 is virtually flesh color information of the face image.

In step S18, the similarity determination unit 35 performs the above processing to acquire the right eye contour shape RE1, the left eye contour shape RE2, the nose contour shape RN, the mouth contour shape RM, the middle point P, the upper edge P1, the lower edge P2, barycentric positions PRE1, PRE2, PRN, and PRM, and face color information. The face color extraction unit 43 acquires these information items as reference mask information. Then, the similarity determination unit 35 compares the obtained reference mask information with the reference mask information already stored in the reference mask information storage unit 25 to determine whether there is a similarity or match.

In step S18, if there is no similarity or no match between the obtained reference mask information and the reference mask information already stored in the reference mask information storage unit 25, the processing proceeds to step S19.

In step S19, the similarity determination unit 35 newly stores the reference mask information acquired from the reference mask information extraction unit 34 in the reference mask information storage unit 25 and finishes the processing.

In step S18, for example, if there is a similarity or match between the obtained reference mask information and the reference mask information already stored in the reference mask information storage unit 25, the processing in step S19 is skipped and the acquired reference mask information is discarded.

That is, the reference mask information similar to or the same as the reference mask information already stored is not stored newly and only new reference information is stored to prevent the reference mask corresponding to a face image of the same person from being stored repeatedly.

Due to the above processing, it is possible to generate reference mask information based on a face image that can be recognized by face image detection processing of the related art among face images included in the input image and to store it in the reference mask information storage unit 25. As a result, it is possible to search for a face image even though it is rotated by using the reference mask based on the reference mask information as described later.

### [Face Image Search Processing]

Next, face image search processing will be described below with reference to the flowchart in the FIG. 5.

In step S31, the face color area extraction unit 61 sets unprocessed reference mask information of the reference mask information stored in the reference mask information storage unit 25 to the target reference mask information.

In step S32, the face color area extraction unit 61 reads face color information from the target reference mask information and searches for an area including the color matching the face color information as the face color area from the input image. At this time, the face color area extraction unit 61 searches for the area including any value from the minimum value to the maximum value of flesh colors included in the face color information.

In step S33, the face color area extraction unit 61 determines whether the face color area has been searched for and, if it has not been searched for, the processing returns to step S31. In this case, since the face color area of the corresponding person is not present in the target reference mask information, it is assumed that a search of the face image is difficult and processing by the reference mask information of another target is performed.

In step S33, if the face color area has been searched for, the processing proceeds to step S34.

In step S34, the face color area extraction unit 61 supplies the searched face color area to the high frequency component extraction unit 62. The high frequency component extraction unit 62 applies a high pass filter such as the Sobel filter, Prewitt filter, or Laplacian filter to the supplied face color area to extract an edge image including high frequency components and supplies the edge image to the reference mask comparison unit 63.

In step S35, the reference mask comparison unit 63 reads the target reference mask information of the reference mask information stored in the reference mask information storage unit 25 and generates a reference mask based on the reference mask information. That is, the reference mask comparison unit 63 places the right eye contour shape RE1 in the barycentric position PRE1, the left eye contour shape RE2 in the barycentric position PRE2, the nose contour shape RN in the barycentric position PRN, and the mouth contour shape RM in the barycentric position PRM based on the reference mask information. This generates the reference mask BM′.

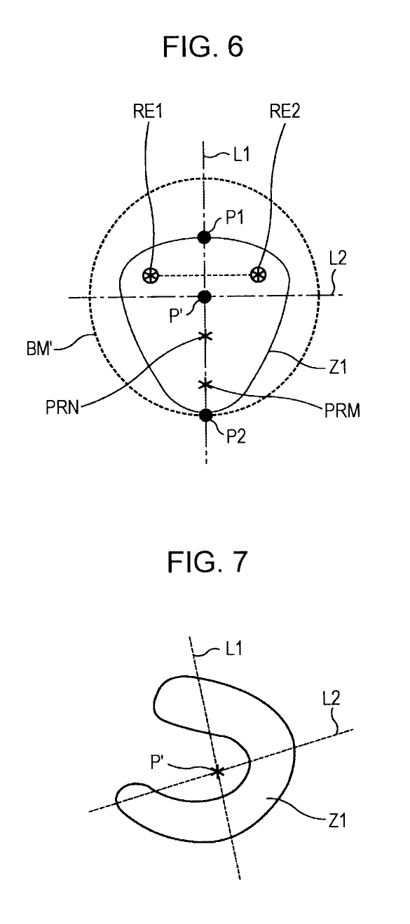

In step S36, the face color area center position calculation unit 65 calculates a center position P′ of the supplied face color area and supplies the center position P′ to the reference mask comparison unit 63 and the face color area center matching determination unit 66. More specifically, the face color area center position calculation unit 65 sets a straight line L1 so that the distance between edges of a face color area Z1 becomes longest and a straight line L2 so that it is orthogonal to the straight line L1 and the distance between edges of a face color area Z1 becomes longest, as shown in, for example, the face color area Z1 in FIG. 6. Then, the face color area center position calculation unit 65 calculates the intersection point of the straight lines L1 and L2 as the center point P′.

In step S37, the face color area center matching determination unit 66 determines whether the center position P′ is present within the face color area Z1 from the center position P′ and the face color area Z1. For example, when the center position P′ is present within the face color area Z1 as shown in FIG. 6, the center position P′ is assumed to be present within the face color area Z1 from the center position P′ and the face color area Z1 and the processing proceeds to step S38.

In step S38, the reference mask comparison unit 63 adjusts the center position using the center position adjustment unit 81 so that the center position P′ in the face color area Z1 matches the middle point P (in FIG. 4) of the generated reference mask and superimposes the reference mask RM′ on the face color area Z1.

In step S39, the reference mask comparison unit 63 adjusts the scale using the scale adjustment unit 82 so that the upper edge P1 and the lower edge P2 of the reference mask BM′ become the intersection points of the straight line L1 or L2 and the edges of the face color area Z1. That is, as shown in FIG. 6, the scale of the reference mask BM′ is adjusted so that the upper edge P1 and the lower edge P2 match the intersection points of the straight line L1 and the face color area Z1.

In step S40, the reference mask comparison unit 63 controls the rotary unit 83 to set the reference mask BM′ whose scale was adjusted so as to be superimposed on the face color area Z1 detected as an edge image in a certain rotation reference position. For example, if the position where both the upper edge P1 and the lower edge P2 of the reference mask BM′ are present in the straight line L1 is assumed to be the rotation reference position, the reference mask BM′ is set as shown in FIG. 6.

In step S41, the reference mask comparison unit 63 makes the high frequency component presence determination unit 84 determine whether high frequency components with shapes identical to the right eye contour shape RE1, the left eye contour shape RE2, the nose contour shape RN, and the mouth contour shape RM are present in the positions corresponding to these shapes RE1, RE2, RN, and RM. In step S41, when there are not the high frequency components in the face color area Z that have the shapes identical to the right eye contour shape RE1, the left eye contour shape RE2, the nose contour shape RN, and the mouth contour shape RM in the positions corresponding to these shapes RE1, RE2, RN, and RM, the processing proceeds to step S42.

In step S42, the reference mask comparison unit 63 makes the rotary unit 83 rotate the reference mask a certain angle about the middle point P. In step S43, the reference mask comparison unit 63 makes the rotary unit 83 determine whether the reference mask has been rotated 360 degrees. If it is determined in step S43 that the reference mask has not been rotated 360 degrees, the processing returns to step S41. That is, if the high frequency components with shapes identical to the right eye contour shape RE1, the left eye contour shape RE2, the nose contour shape RN, and the mouth contour shape RM are not present in the positions corresponding to these shapes RE1, RE2, RN, and RM, steps S41 to S43 are repeated. During this duration, the reference mask BM′ is rotated at certain angle intervals about the middle point P to determine whether there are the high frequency components in the face color area Z that have the shapes identical to the right eye contour shape RE1, the left eye contour shape RE2, the nose contour shape RN, and the mouth contour shape RM in the positions corresponding to these shapes RE1, RE2, RN, and RM each time the reference mask BM′ is rotated.

In step S41, it is determined that there are the high frequency components in the face color area Z that have the shapes identical to the right eye contour shape RE1, the left eye contour shape RE2, the nose contour shape RN, and the mouth contour shape RM in the positions corresponding to these shapes RE1, RE2, RN, and RM, the processing proceeds to step S44. That is, when the contour shapes and their positions of the eyes, nose, mouth of the face image in the face color area Z1 are the same as the contour shapes and their positions of the reference mask, it is assumed that there is a match with the reference mask and the face image of a person registered as reference mask information has been detected.

In step S44, the reference mask comparison unit 63 supplies the image in the face color area Z1 corresponding to the arrangement of parts currently included in the face in the reference mask to the face image search result output unit 64 as the face image of a person registered as the reference mask information. At this time, the reference mask comparison unit 63 also supplies information of the rotation angle of the reference mask together measured when the face image is detected, to the face image search result output unit 64. The face image search result output unit 64 outputs, as the search result, the face image and the information of the rotation angle supplied from the reference mask comparison unit 63.

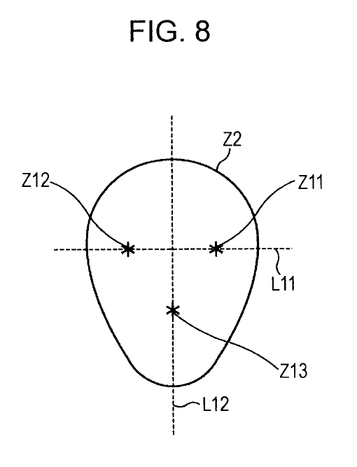

If it is determined in step S37 that the center position P′ is not present within the face color area Z1, the processing proceeds to step S45. As shown in FIG. 7, for example, when the face color area Z1 has a shape not applicable to a face image, the center position P′ obtained on the basis of the above straight lines L1 and L2 is not present within the face color area Z1. In such a case, the center position P′ is assumed to be not present within the face color area Z1 and the processing proceeds to step S45.

If it is determined in step S43 that the reference mask has been rotated 360 degrees, the face image corresponding to the reference mask is assumed to be not present in the face color area Z1 and the processing proceeds to step S45.

In step S45, the face color area extraction unit 61 determines whether unprocessed reference mask information is present in the reference mask information storage unit 25 and, if it is present, the processing returns to step S31. That is, steps S31 to S45 are repeated until the unprocessed reference mask information is not present. If it is determined in step S45 that the unprocessed reference mask information is not present, the processing ends.

Due to the above processing, after the reference mask information is obtained, reference mask image whose position and size were adjusted is superimposed on the detected face color area, so that the face image can be searched for by determining whether there are the contour shapes identical to those of the presence areas of parts while the reference mask is rotated at a certain angle about the middle point P. Since a face image can be searched for only by rotating the reference mask only in the face color area, the amount of calculation can be reduced as compared with face image search processing using general block matching and the face image can be searched for quickly. When a face image is rotated in an input image, the face image is searched for while the reference mask is rotated according to the face image, so the face image can be searched for without reduction in search accuracy even if the face image is rotated 90 degrees or more. In addition, the rotation angle of the face image can also be searched for during a search of the face image. Accordingly, even in a case where the face image is continuously rotated in a moving picture etc., changes in the rotation angle can be recognized and, based on information that depends on the rotation angle, various types of information such as chronological changes in attitude can be obtained.

Since the face image is searched for by placing and rotating the reference mask relative to the face color area, the smaller the angle formed by the rotation reference position and the position where the face image can be recognized, the higher the search speed of the face image.

As in the face color area Z2 shown in FIG. 8, when, for example, the barycentric positions Z11, Z12, and Z13 of the right eye, left eye, and mouth can be recognized from the edge image in the face color area Z2, the rotation reference position of the reference mask may be set together. This enables the face image to be searched for with little rotation of the reference mask, so it is possible to search for the face image at a high speed without reducing search accuracy by reducing the processing load on face image search processing. In addition, since the approximate rotation angle of the face image in the face color area can be identified by recognizing the position of a cap or topknot in the face color area, the face image can be searched for at a higher speed by setting the rotation reference position of the reference mask using an angle corresponding to the approximate rotation angle.

A series of monitoring processes above can be performed not only by hardware, but also by software. When the monitoring processes are performed by software, it is necessary to prepare a computer having specific hardware in which programs constituting the software are incorporated or to install the programs in a general purpose personal computer from a storage media.

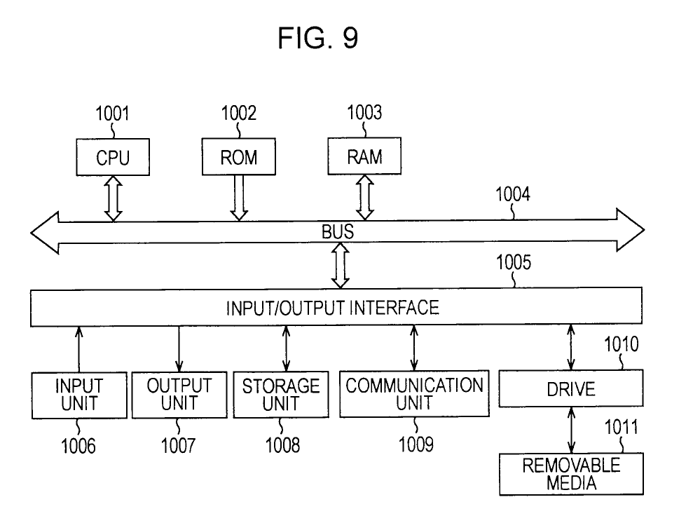

FIG. 9 shows a configuration example of the general purpose personal computer. The general purpose personal computer incorporates the CPU (central processing unit) 1001. The input/output interface 1005 is connected to the CPU 1001 via the bus 1004. The ROM (read only memory) 1002 and the RAM (random access memory) 1003 are connected to the bus 1004.

The components connected to the input/output interface 1005 are, for example, the input unit 1006 including a keyboard with which the user inputs operation commands and a mouse which is an input device, the output unit 1007 which outputs an operation screen and processing result screen to a display device, the storage unit 1008 including a hard disk drive etc. that stores programs or data, and the communication unit 1009 which includes a LAN adapter and performs communication via a network typified by the Internet. In addition, the drive 1010 which reads data from or writes data to the removable media 1011 including a magnetic disc (including a flexible disc), optical disc (CD-ROM (compact disc read only memory)), DVD (digital versatile disc), optical magnetic disc (including MD (mini disc)), or semiconductor memory is connected to the input/output interface.

The CPU 1001 executes various operations according to the program stored in the ROM 1002 or the program that is read from the removal media 1011 such as a magnetic disc, optical disc, optical magnetic disc, or semiconductor memory, installed in the storage unit 1008, and loaded from the storage unit 1008 to the RAM 1003. The RAM 1003 also stores data used by the CPU 1001 to execute various operations, as necessary.

In this specification, the steps describing programs to be stored in a storage media include not only the processes that are executed chronologically in the order in which they are listed, but also the processes that are not necessarily executed chronologically and executed in parallel or individually.

In this specification, the system represents an entire apparatus including a plurality of devices.

The present application contains subject matter related to that disclosed in Japanese Priority Patent Application JP 2009-290903 filed in the Japan Patent Office on Dec. 22, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a face image detection means for detecting a face image from an image;
a reference mask generation means for generating a reference mask based on an arrangement of parts included in the face image detected by the face image detection means;
a face color area detection means for detecting a face color area from the image; and
a face image search means for searching the face color area detected by the face color area detection means for the face image using the reference mask.

2. The image processing apparatus according to claim 1, further comprising a high frequency component extraction means for extracting high frequency components in the face image detected by the face image detection means, wherein the reference mask generation means recognizes the arrangement of the parts included in the face image based on distribution of the high frequency components in the face image detected by the face image detection means and generates the reference mask based on the arrangement of the parts recognized.

3. The image processing apparatus according to claim 1, further comprising a high frequency component extraction means for extracting high frequency components in the face color area, wherein the face image search means adjusts a size and a position of the reference mask and rotates the reference mask about a certain position on the reference mask so that the reference mask matches the face color area, and searches for the face image by determining whether distribution of the high frequency components detected by the high frequency extraction means matches a positional relationship of the parts in the reference mask.

4. The image processing apparatus according to claim 3, wherein the face image search means rotates the reference mask about the certain position on the reference mask from a position where the distribution of the high frequency components detected by the high frequency extraction means has a certain relation with the positional relationship of the parts in the reference mask and the face image search means searches for the face image by determining whether the distribution of the high frequency components detected by the high frequency extraction means matches the positional relationship of the parts in the reference mask.

5. An image processing method comprising the steps of:
detecting a face image from an image;
generating a reference mask based on an arrangement of parts included in the face image detected by the step of detecting the face image;
detecting a face color area from the image; and
searching the face color area detected by the step of detecting the face color area for the face image using the reference mask.

6. A program that instructs a computer to execute processing comprising the steps of:
detecting a face image from an image;
generating a reference mask based on an arrangement of parts included in the face image detected by the step of detecting the face image;
detecting a face color area from the image; and
searching the face color area detected by the step of detecting the face color area for the face image using the reference mask.

7. An image processing apparatus comprising:
a face image detector detecting a face image from an image;
a reference mask generator generating a reference mask based on an arrangement of parts included in the face image detected by the face image detector;
a face color area detector detecting a face color area from the image; and
a face image searcher searching the face color area detected by the face color area detector for the face image using the reference mask.
